(19) United States
(12) Patent Application Publication
(10) Pub. No.: US 2003/0232206 A1
(43) Pub. Date: Dec. 18, 2003

(54) Method for improving metal surfaces to prevent thermal tarnishing and component with the metal surface

(76) Inventors: Frank Jordens, Traunstein (DE); Jurgen Salomon, Trostberg (DE); Gerhard Schmidmayer, Bad Endorf (DE); Bernhard Walter, Nersingen (DE)

Correspondence Address: LERNER AND GREENBERG, P.A., POST OFFICE BOX 2480, HOLLYWOOD, FL, 33022-2480, US

(21) Appl. No.: 10/465,243

(22) Filed: Jun. 19, 2003

Related U.S. Application Data
(63) Continuation of application No. PCT/DE01/04824, filed on Dec. 19, 2001.

(30) Foreign Application Priority Data
Dec. 19, 2000 (DE) 100 64 134.2

(51) Int. Cl. B05D 3/10; B05D 3/04; B32B 15/04

(52) U.S. Cl. 428/469; 427/307; 428/472

(57) ABSTRACT

A method for coating metal surfaces, excluding lithographic plates, includes either, in the sequence specified, (a) a step involving mechanical and/or chemical roughening of the metal surface to be coated; and a step involving coating of the roughened surface, wherein a layer with a thickness ranging from 100 nm to less than 1 μm is applied, or introducing a secondary phase as the roughening step at the same time as the coating step, wherein a layer with a thickness ranging from 100 nm to less than 1 μm is applied. A component produced with the method is also provided.

### CROSS-REFERENCE TO RELATED APPLICATION

This application is a continuation of copending International Application No. PCT/DE01/04824, filed Dec. 19, 2001, which designated the United States and was not published in English.

### BACKGROUND OF THE INVENTION

### FIELD OF THE INVENTION

This present invention relates to a method to prevent or at least reduce the yellowing and/or tarnishing of metal surfaces (e.g., stainless steel, copper, brass, and bronze) that are exposed to elevated temperatures and a component having the improved metal surface.

Common stainless steels such as grade 1.4301 (chromium-nickel steel) and 1.4016 (chromium steel) corrode at temperatures from 200° C. to 230° C. in an air atmosphere. As a result of oxygen, oxide layers form on the surface, which layers frequently cause discolorations, for example, yellowish discolorations (tarnishing), which are undesirable for users. This affects household devices that, due to their function, must be exposed to high temperatures (e.g., up to 500° C.) (e.g., ovens and stoves, in particular, pyrolysis ovens, insertion parts such as grills or baking pans, and covers).

Methods are known from the prior art to increase corrosion resistance by treating the steel surfaces. These methods include heat exchange in an inert atmosphere in combination with dyeing methods, as described in Japanese Patent Application No. JP 06079990, disclosed on Apr. 19, 1994. Furthermore, corrosion resistance can be increased by electrolytic polishing.

European Patent Application EP 00 101 186.5 (published as EP-A 1 022 357), furthermore discloses that, by specific oxidation and dyeing operations, tarnishing of stainless steels as a result of temperatures of up to 350° C., which are common in the household, can be suppressed. Otherwise, no quality has been described so far that, without applying a protective layer, prevents thermally induced tarnishing at temperatures of more than approx. 230° C. with prolonged use.

Accordingly, another approach to suppress tarnishing lies in applying protective layers by wet chemical procedures. This includes, on one hand, the application of water glass to metal surfaces as well as the application of layers by the sol-gel process (compare e.g. German Published, Non-Prosecuted Patent Application DE 197 14 949 A, corresponding to U.S. Pat. No. 6,162,498 to Menning et al., to applicant: INM). Such layers act as a diffusion barrier for oxygen. They are applied, among other things, to prevent interference colors, at a thickness of more than 1 μm of thickness after thermal densification (DE 197 14 949 A). Thinner layers, e.g., those on a sol-gel basis, lead to optically undesirable interferences.

Sol-gel processes are particularly used to apply vitreous layers. The sol-gel techniques are well known to those skilled in the art and described in detail, for example, in Brinker-Scherer, The Physics and Chemistry of Sol-Gel Processing, Sol-Gel Science, Academic Press (1990). Such sol-gel processes are hydrolysis-condensation reactions (e.g., of silanes such as RₙSiX₄₋ₙ or a mixture of several such silanes, wherein R may be, e.g., hydrogen or an aliphatic or aromatic radical and X may be a hydrolyzable radical such as alkoxy or phenoxy), in which, upon complete removal of water from the reaction product (chemically meaning condensation; water from the solvent, if any, is still present) structures such as, for example, Si—O bonds are formed while such product is simultaneously branched and crosslinked. The particle size (particle diameter) in the structures is 100 nm or less. By removing the solvent, a gel forms (with increased viscosity and increased degree of crosslinking) that is subsequently dried to form an aerogel and, finally, by further heating (to approx. 500° C.), produces a layer (in case silanes are used: a vitreous layer) containing both silicon as well as oxygen (at a stochiometric ratio of approx. 1 to 2). These vitreous layers on the basis of Si and O shall, hereinafter, be referred to as Si—O layers.

Such a sol-gel process has been described for silanes with the general formula RₙSiX₄₋ₙ in DE 197 14 949 A. The vitreous layers described therein, in addition to improving protection against corrosion/tarnishing, also facilitate cleaning as well as improve, depending on the thickness, the scratching resistance of the substrate. However, presumably as a result of shrinking processes and differences in the expansion coefficients, they are prone to cracking at a layer thickness of 2 μm and above. This propensity to cracking is due to the fact that the layers that have been treated in such a manner, due to the outgassing of organic components, lose their flexibility at temperatures of more than approx. 350° C. In addition, insofar as production technology is concerned, more complicated geometries cannot be coated with these tolerances of thickness. In case the layers are applied at a lower thickness (less than 1000 nm), while such layers are not sensitive to cracking and can also be applied in a manageable manner in diluted form, they do produce interference colors, which are usually considered undesirable by users.

Due to their propensity for cracking, however, thicker sol-gel layers (layer thickness>2000 nm) on stainless steel surfaces, but also on other metals such as copper, brass, and bronze, in particular, in case they are used in the household (ovens, stoves, etc.), are unsuitable from a technical and practical point of view, considering that cracking leads to a loss of functionality.

For the development of their protective effect, the vitreous Si—O layers require temperatures above the tarnishing temperature of the respective metal, e.g., common stainless steels (refined steels) (the tarnishing temperatures of steel are usually around 200+/−20 C.). The term “development of their protective effect” means, on one hand, densification processes of the layer, in which case the densified layer acts as a diffusion barrier for oxygen, but, on the other hand, also refers to chemical reactions on the contact surface of the steel and/or metal/alloy that prevent the formation of visually undesirable oxide layers.

In case work is performed in an oxygen-containing atmosphere (e.g., air), it is essential that the protective effect is (has been) achieved at temperatures and/or at times below and/or before which visible tarnishing can (could) occur. As noted in the preceding paragraph, this is not the case without further auxiliary measures. For that reason, during sol-gel processes (in particular, in case silanes are used to form Si—O layers), such auxiliary measures are added in the form of alkalis (as network modifiers). Common alkaline sources are those mentioned in DE 197 14 949 A (at Col. 3, last paragraph), in particular, NaOH, KOH, Mg(OH)₂, Ca(OH)₂. These network modifiers are integrated in the Si—O network and interrupt the same, as a result of which the Si—O network modified in such a manner, depending on the concentration of the alkali(s) used, approximates water glass to a higher or lesser degree. Among other things, the effect of the network modifiers lies in lowering the densification temperatures of the layers. In other words, the onset of the protective effect and, consequently, protection against oxygen can be achieved at lower temperatures compared with sol-gel processes without using network modifiers. In turn, the sequence in terms of time and/or temperature is inverted, the layer protecting against tarnishing can form at times and/or at temperatures before and/or below those at which visible tarnishing occurs.

On the other hand, however, the use of network modifiers involves a significant disadvantage: usually, their use reduces the chemical resistance of the layers. In case chemically particularly resistant (vitreous) layers are desired, they must be thermally densified in an oxygen-free atmosphere (e.g., by using nitrogen or possibly also argon as a protective gas) without using network modifiers. However, this, in turn, involves a relatively significant effort, which makes a sol-gel process in a protective gas-atmosphere relatively uninteresting from an economic point of view.

Other than in the case of using silanes in sol-gel processes, sol-gel processes on the basis of suitable Ti, Zr, Al, and/or B compounds are not used, among other things, because the protective effect does not develop at temperatures below the tarnishing temperature, i.e., the stainless steel/metal/alloy already yellows/tarnishes during the protective treatment.

### SUMMARY OF THE INVENTION

It is accordingly an object of the invention to provide a method for improving metal surfaces to prevent thermal tarnishing that overcomes the hereinafore-mentioned disadvantages of the heretofore-known devices and methods of this general type and that provides a method that makes it possible to coat stainless steel surfaces, but also surfaces of other metals or alloys such as copper, brass, and bronze, without using network modifiers while, at the same, preventing the layer providing protection against tarnishing from forming only at times and/or at temperatures after and/or above which visible tarnishing has already occurred. The use of such a method is intended to maintain the original metallic look of the surface, even in case the sol-gel process is performed on the basis of suitable Ti, Zr, Al, and/or B compounds.

An aspect of the invention provides a method that ensures both proper corrosion/tarnishing protection of the stainless steel and/or other metals and alloys even when exposed to temperatures of up to 450° C. over prolonged periods of time, preferably, up to 500° C., and even up to 550° C., while simultaneously maintaining the original metallic look and permitting simple and/or improved cleaning of the substrate, i.e., metal and/or alloy, and, preferably, prevent, although at the least significantly reduce, the appearance of interference colors at thin layers. Due to the low thickness of the layer, the problem of keeping the cracking propensity of the coating low is also resolved.

Finally, another aspect of the invention lies in providing a method that attains both of aforementioned goals simultaneously in a single procedure.

With the foregoing and other objects in view, there is provided, in accordance with the invention, a method for coating metal surfaces excluding lithographic plates, including one of the steps of at least one of mechanically and chemically roughening the metal surface to be coated and subsequently coating the roughened surface with a layer having a thickness ranging from approximately 100 nm to approximately 1 μm, and introducing a secondary phase by at least one of mechanically and chemically roughening the metal surface to be coated at the same time as coating the roughened surface with a layer having a thickness ranging from approximately 100 nm to approximately 1 μm.

In accordance with another mode of the invention, the coating step is carried out by coating the roughened surface with a translucent layer having a thickness ranging from approximately 100 nm to less than 1 μm and being based upon compounds selected from the group consisting of Si, Zr, Ti, B, and Al compounds, preferably, being based upon Si compounds.

In accordance with a further mode of the invention, the introduction of the secondary phase is carried out by incorporating light-diffusing particles, preferably, of TiO₂, Al₂O₃, ZrO₂, and SiO₂.

In accordance with an added mode of the invention, geometries of the mechanical and/or chemical roughening are selected to range from approximately 50 nm to approximately 1000 nm and/or from approximately 200 nm to approximately 500 nm, and geometries of the physical roughness are selected to range from approximately 2 nm to approximately 100 nm, preferably, approximately 5 nm to 50 nm, in particular, from approximately 2 nm to 30 nm, further in particular, from approximately 5 nm to 25 nm, and, particularly preferably, from approximately 10 nm to 20 nm.

In accordance with an additional mode of the invention, the metal surface to be coated is a steel surface, preferably, of a chromium and/or nickel-containing surface.

In accordance with yet another mode of the invention, the coating is applied in a thickness ranging from approximately 200 nm to approximately 850 nm, preferably, from approximately 300 nm to approximately 750 nm, and, in particular, from approximately 350 nm to approximately 600 nm.

In accordance with yet a further mode of the invention, the roughening and coating steps are preceded with a step of treating the metal surface to approx. 300° C. to increase the tarnishing temperature of the metal surface resulting in a tarnishing temperature of the metal surface being above a temperature where a protective effect of the, e.g., Si—O layer occurs.

In accordance with yet an added mode of the invention, the treating step is carried out by heating the metal surface to up to 550° C. and by subsequently dyeing the heated surface in mineral acid.

In accordance with yet an additional mode of the invention, the coating step is carried out with a wet chemical process, in particular, a sol-gel process.

In accordance with again another mode of the invention, the coating step is carried out utilizing, in particular, for the sol-gel process, initial compounds having at least one of the general formulas RₙMeX₄₋ₙ and RₙMeX₃₋ₙ, where X is one of hydrolyzable groups and hydroxy groups, R is at least one of hydrogen, alkyl, alkenyl, and alkinyl groups with up to 12 C atoms and aryl, aralkyl, and alkaryl groups with 6 to 10 C atoms, n is 0, 1, or 2, always provided that at least one compound with n=1 or 2 is used, and Me is Si, Al, Zr, B, or Ti.

With the objects of the invention in view, there is also provided a method for coating metal surfaces excluding lithographic plates, including one of the steps of roughening the metal surface to be coated with at least one of a mechanical roughening and a chemical roughening and subsequently coating the roughened surface with a layer having a thickness ranging from approximately 100 nm to approximately 1 μm, and introducing a secondary phase by roughening the metal surface to be coated with at least one of a mechanical roughening and a chemical roughening at the same time as coating the roughened surface with a layer having a thickness ranging from approximately 100 nm to approximately 1 μm.

With the objects of the invention in view, there is also provided a component including a metal surface excluding lithographic plates being one of at least one of mechanically and chemically roughened and subsequently coated with a layer having a thickness ranging from approximately 100 nm to approximately 1 μm, and at least one of mechanically and chemically roughened at the same time as coated with a layer having a thickness ranging from approximately 100 nm to approximately 1 μm.

With the objects of the invention in view, there is also provided a component, including a metal surface excluding lithographic plates being one of roughened with at least one of a mechanical roughening and a chemical roughening and subsequently coated with a layer having a thickness ranging from approximately 100 nm to approximately 1 μm, and roughened with at least one of a mechanical roughening and a chemical roughening at the same time as coated with a layer having a thickness ranging from approximately 100 nm to approximately 1 μm.

Other features that are considered as characteristic for the invention are set forth in the appended claims.

Although the invention is described herein as embodied in a method for improving metal surfaces to prevent thermal tarnishing and component with the metal surface, it is, nevertheless, not intended to be limited to the details provided because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments.

### DESCRIPTION OF THE PREFERRED EMBODIMENTS

It has been found that the solution of these problems requires a method including the steps of:

(i) optionally, providing for a treatment of the metal surface to increase its tarnishing temperature, as a result of which, the first of the three goals mentioned above is attained;

(ii) mechanically and/or chemically roughening the metal surface to be coated, as a result of which, the second of the aforementioned goals is achieved; and

(iii) finally, coating the roughened surface by, for example, a sol-gel process, wherein the layer is applied at a thickness of less than 1000 nm, preferably, 800 nm or less, 600 nm or less, 500 nm or less, or 400 nm or less, and, as result of which, the third goal is achieved, provided this step follows step (ii).

One variation of this method also includes the optional step (i) followed by step (ii), which is performed simultaneously with the coating step (iii), wherein step (ii) involves the introduction of a secondary phase and the layer is applied at a thickness of less than 1000 nm, preferably, 800 nm or less, 600 nm or less, 500 nm or less, or 400 nm or less.

Consequently, one aspect of the present invention concerns the method outlined above. Another aspect of the present invention concerns a component, for example, a metallic sheet made from chromium-nickel steel, that has been subjected to such a method.

Optionally, step (i) can be omitted without a risk that the goals defined above will not be attained. This may be possible by selecting a special type of steel that (even in an oxygen-containing atmosphere) tarnishes at a relatively late stage.

Examples for such special steels are Cronifer 45 and/or Cronifer 2, by Krupp VDM.

For those skilled in the art, it goes without saying that step (i) is also not necessary in case thermal densification occurs in an inert and/or non-oxidizing atmosphere (in which case, based on the state of the art, no network modifier is required, either).

In all other cases, however, step (i) is needed to attain the formulated goal(s) of providing surfaces that are tarnishing-free and in case the above-mentioned prerequisites are not met (no use of special steel as specified for the embodiment described in the next-to-last paragraph; no network modifiers; no work in a non-oxidizing atmosphere).

Preferably, the metal surfaces to be treated are stainless steel surfaces, in particular, steel surfaces grades 1.4301 and 1.4016 (chromium-nickel and/or chromium-steel), which otherwise, i.e., untreated, oxidize at working temperatures of 200° C. and above in the air atmosphere and, as a result thereof, exhibit a yellowish discoloration during partial step (iii) (in the absence of network modifiers).

Based on the findings of the present invention, chemically resistant (because network modifier-free) sol-gel layers can be applied to substrates without tarnishing as long as and/or because the substrates and/or their surfaces, after above step (i), have tarnishing temperatures that are significantly above 200° C., e.g., 250° C., preferably, 300° C. This means that, in accordance with a preferred embodiment (α) of the present invention, a first step (i) of the method in accordance with the present invention involves the treatment of the metal surface to increase its tarnishing temperature and, therefore, achieve the first of the three goals mentioned above.

Step (i) of the preferred embodiment (α) can be achieved by any method where the metal can achieve tarnishing protection before a discoloring oxide layer is formed. Preferably, this step uses the method described in EP 1 022 357 A. Preferably, step (i) includes the steps of heating the metal surface to a temperature of up to 550° C. and, subsequently, dyeing the heated surface with mineral acid (as described in EP 1 022 357 A). It is particularly preferred to increase the tarnishing temperature of the metal surface to approx. 300° C., as a result of which, the tarnishing temperature is above the temperature at which the protective effect of the, e.g., Si—O layer occurs, considering that, after such a step (i) (and the following step (ii)), step (iii) can be performed in an oxygen atmosphere without requiring any network modifiers.

Hereinafter, this step (i) shall be referred to as the “step of increasing the tarnishing temperature” or “step for the increase of the tarnishing temperature”. This step is followed by step (ii), wherein the metal surface is roughened, and step (iii), a conventional coating process, e.g., a sol-gel process, as a result of which, protection against tarnishing of the metal/alloy treated in such a manner, such as steel, copper, brass, or bronze, is maintained even at temperatures of up to 550° C.

According to a preferred embodiment of the present invention, the organic components (e.g., methyl, ethyl, 1-propyl, isopropyl radicals; insofar as the chemistry, in general, and organic radicals, in particular, are concerned, compare this to the Chemistry Section below) of the layers are not completely eliminated during thermal densification. As a result, an easy-to-clean, tarnishing-resistant surface with little surface energy is obtained. For those skilled in the art, it is easy to determine at which temperature the elimination by thermal densification must occur in accordance with this preferred embodiment. A precise temperature range or even value cannot be specified because such temperature range or value depends on a number of parameters (e.g., qualitative and quantitative chemical composition) that are familiar to those skilled in the art. Usually, the elimination through thermal densification is performed at a temperature above the (subsequent) application temperatures. This means that, in case the surface-treated metal is planned to be used in a stove where it will be exposed to temperatures of up to 450° C., elimination through thermal densification should be performed at temperatures of 450° C. or above 450° C., preferably, at approx. 470, at approx. 480, at approx. 490, or approx. 500° C.

It has, furthermore, been found that the interference colors of the layers that occur at a thin layer thickness can be suppressed by mechanical and/or chemical and/or physical roughening of the (refined) steel surface. For the purposes of the present invention, physical roughening is defined as the (physical) introduction of secondary phases (such as light-diffusing particles or pores). As examples for the different types of roughening methods, grinding or blasting, in particular, sandblasting or peening (mechanical), etching, e.g., by using acids such as phosphoric, sulphuric, or hydrochloric acid (chemical), to produce a microstructure in the surface to be treated (unlike etching, the dyeing process described in EP 1 022 357 A and to be used as step (i) in accordance with the present invention represents merely a cleaning process for removing the oxide layer, without even providing a microstructure in the (substrate) surface to be treated), but also the incorporation of light-diffusing particles and/or pores (physical) shall be mentioned.

The pores are, preferably, provided as air-filled spaces between the particles. Those skilled in the art are aware of how to provide such spaces between particles (in this respect, also compare the paragraph following the next paragraph below). As light-diffusing particles, TiO₂ and ZrO₂ are particularly suited; generally speaking, all particles are suitable whose refractive index is larger than that of the respective layer. In all cases, the interference-breaking geometries in accordance with the present invention for mechanical, chemical, and/or physical roughness range from 2 to 1000 nm, preferably, from 15 to 500 nm, from 40 to 300 nm, from 50 to 250 nm, and/or from 100 to 200 nm (all specified ranges refer to diameters). The preferred range for chemical and mechanical roughness is from 50 to 1000 nm, in particular, from 200 to 500 nm. The preferred range for the (light-diffusing) particles (first form of physical roughening) is 2 to 30 nm, in particular, 5 to 25 or 10 to 20 nm (substantially depending on the type of particles and their refractive index). The preferred ranges for pores (second form of physical roughening) are 2 to 100 nm, in particular 5 to 50 nm.

In case light-diffusing particles and/or pores are used in step (ii) to prevent interferences, a certain ratio between Me (e.g., Si) of the matrix, on one hand, and particles and/or pores, on the other hand, must be ensured. In this respect, it is crucial that the percentage by volume of particles/pores in the thermally densified layer be 0.05 to 20%, preferably, 0.1 to 15%, although, particularly preferably, 1 to 5%.

While those skilled in the art are fully aware of how to incorporate pores or light-diffusing particles as well as achieve mechanical or chemical roughness in the layers, the method shall be briefly outlined for pores and particles, nonetheless. Particles can be incorporated by adding light-diffusing particles during the sol-gel process that ultimately, due to their refractive index (which is different from that of the matrix, i.e., the layer) and smaller size of approx. 2 to 30 nm (e.g., 20 nm; specified as the particle diameter) can prevent the occurrence of interference colors or at least significantly reduce their intensity. As suitable particles, e.g., Al₂O₃, TiO₂, ZrO₂, and SiO₂ shall be mentioned.

There are basically three options to incorporate pores to avoid interference colors. One, during the sol-gel process, a blowing agent is added that, at the very latest during the thermal densification process, i.e., during the conversion of the aerogel into the coating, is eliminated while leaving behind the pores. Alternatively, the concentration of the initial substances for the hydrolysis-condensation reactions (e.g., of the silanes) can be lowered to be able to incorporate pores (air) in the matrix. Lastly, the sol-gel process can be controlled such that, without adding particles, the process produces a porous layer through incomplete crosslinking/densification.

The layers applied in accordance with the present invention are transparent, i.e., they do not change the look of the metal surface.

Chemistry of the Sol-Gel Process in Accordance with the Present Invention

In accordance with the present invention, the initial compounds for hydrolysis and subsequent condensation are compounds with the general formula RₙMeX₄₋ₙ, wherein X and R are defined in the same manner as in DE 197 14 949 A (see Col. 2, Rows 18 through 34, Col. 3, Rows 1 through 9), wherein n is 0, 1, 2, or 3, and wherein Me is either Si, Al, Zr, B, or Ti. In case Me=Al or B, it is apparent for those skilled in the art that the formula specified above, because of the trivalence of the central atoms Al and B, must be RₙMeX₃₋ₙ. Preferred are compounds where Me=Si; where R=hydrogen, a methyl-, ethyl-, i-propyl-, n-propyl-, vinyl-, allyl-, or phenyl radical, wherein not all R need to be the same; where X=OH, a methoxy-, ethoxy-, or phenoxy radical or Hal (F, Cl, Br, I, preferably, Cl and Br), wherein not all X need to be the same; and where n=0, 1, or 2. The organic radicals R and/or X usually have from 1 to 16 C atoms, and 1 to 12, in particular, 1 to 8, C atoms are preferred (for the aryl radicals, it goes without saying that 6 and/or 10 C atoms are preferred). Particularly preferred are radicals with 1 to 4 (alkyl, alkenyl, alkinyl) and/or 6 (aryl) and/or 7 to 10 (aralkyl, alkaryl) C atoms.

Particularly preferred are compounds where Me=Si; R=hydrogen, a methyl-, ethyl-, or phenyl radical, wherein not all R need to be the same; where X=OH, a methoxy-, ethoxy-, or phenoxy radical, wherein not all X need to be the same; and where n=0 or 1.

At least one compound with the general formula RₙMeX₄₋ₙ must be a compound where n=2, 1, and/or 0 and/or RₙMeX₃₋ₙ must be a compound where n=1 or 0, because, otherwise, no formation of a layer is possible (in case n=3 and/or 2, e.g., silane/borane only has one hydrolyzable radical X and can, therefore, only react with one molecule).

Preferably, two, three, or more compounds with the general formula RₙMeX₄₋ₙ and/or RₙMeX₃₋ₙ are used in combination wherein the average ratio R to Me (corresponding to n) on a molar basis is, preferably, from 0.2 to 1.5.

The hydrolysis and condensation reactions (sol-gel processes) are, preferably, performed in a solvent mixture of water and an organic solvent such as methanol, ethanol, acetone, ethyl acetate, DMSO, or dimethyl sulfone. The organic solvent may also be a mixture of two or several solvents. All of the aforementioned solvents and any solvents that can be used in accordance with the present invention can be mixed with water. As a result, hydrolysis can proceed without separation of phases.

The coating (composition) can be applied to the metal surfaces in a number of different ways known from prior art: by dipping, spin-depositing, spraying, flooding, or, by rubbing it in; dipping the metal surface in a bath of, for example, silanes is a preferred method.

The thickness at which the layers are applied in accordance with the present invention ranges from 100 to less than 1000 nm, preferably, from 200 to 850 nm, particularly preferably, from 300 to 750 nm, and, very particularly preferably, from 350 to 600 nm. However, a layer thickness from 100 to 300 nm, and, even more so, from 100 to 200 nm, is also preferred within the scope of the present invention.

### EXAMPLE

Chromium-steel 1.4016 (without tarnishing) dyed by using the method described in EP 1 022 357 A (step (i)) and subsequently peened (step (ii)) was dip-coated with a 5% solution of Dynasil GH 02 (according to the manufacturer, Degussa Hüls, the Dynasil solution is based on hydrolyzed and partially condensated silanes) in 1-butanol, dried, and thermally densified at a temperature of 550° C. After the treatment, the steel did not tarnish even at a temperature of 500° C. (holding time of ten hours). No interference colors were observed.

We claim:

1. A method for coating metal surfaces excluding lithographic plates, which comprises:
one of:
at least one of mechanically and chemically roughening the metal surface to be coated and subsequently coating the roughened surface with a layer having a thickness ranging from approximately 100 nm to approximately 1 μm; and
introducing a secondary phase by at least one of mechanically and chemically roughening the metal surface to be coated at the same time as coating the roughened surface with a layer having a thickness ranging from approximately 100 nm to approximately 1 μm.

2. The method according to claim 1, which further comprises carrying out the coating step by coating the roughened surface with a translucent layer having a thickness ranging from approximately 100 nm to less than 1 μm and being based upon compounds selected from the group consisting of Si, Zr, Ti, B, and Al compounds.

3. The method according to claim 1, which further comprises carrying out the coating step by coating the roughened surface with a translucent layer having a thickness ranging from approximately 100 nm to less than 1 μm and being based upon Si compounds.

4. The method according to claim 1, which further comprises carrying out the introduction of the secondary phase by incorporating light-diffusing particles.

5. The method according to claim 4, which further comprises incorporating light-diffusing particles selected from at least one of the group consisting of TiO₂, Al₂O₃, ZrO₂, and SiO₂ particles.

6. The method according to claim 4, which further comprises:
selecting geometries of the at least one of mechanical and chemical roughening to range from approximately 50 nm to approximately 1000 nm; and
selecting geometries of the physical roughness to range from approximately 2 nm to approximately 100 nm.

7. The method according to claim 6, which further comprises selecting geometries of the physical roughness to range from approximately 5 nm to approximately 50 nm.

8. The method according to claim 6, which further comprises selecting geometries of the physical roughness to range from approximately 2 nm to approximately 30 nm.

9. The method according to claim 6, which further comprises selecting geometries of the physical roughness to range from approximately 5 nm to approximately 25 nm.

10. The method according to claim 6, which further comprises selecting geometries of the physical roughness to range from approximately 10 nm to approximately 20 nm.

11. The method according to claim 4, which further comprises:
selecting geometries of the at least one of mechanical and chemical roughening to range from approximately 200 nm to approximately 500 nm; and
selecting geometries of the physical roughness to range from approximately 2 nm to approximately 100 nm.

12. The method according to claim 11, which further comprises selecting geometries of the physical roughness to range from approximately 5 nm to approximately 50 nm.

13. The method according to claim 11, which further comprises selecting geometries of the physical roughness to range from approximately 2 nm to approximately 30 nm.

14. The method according to claim 11, which further comprises selecting geometries of the physical roughness to range from approximately 5 nm to approximately 25 nm.

15. The method according to claim 11, which further comprises selecting geometries of the physical roughness to range from approximately 10 nm to approximately 20 nm.

16. The method according claim 1, wherein the metal surface to be coated is a steel surface

17. The method according claim 16, wherein the metal surface to be coated is at least one of a chromium and nickel-containing surface.

18. The method according to claim 1, which further comprises applying the coating in a thickness ranging from approximately 200 nm to approximately 850 nm.

19. The method according to claim 1, which further comprises applying the coating in a thickness ranging from approximately 300 nm to approximately 750 nm.

20. The method according to claim 1, which further comprises applying the coating in a thickness ranging from approximately 350 nm to approximately 600 nm.

21. The method according to claim 1, which further comprises preceding the roughening and coating steps with a step of treating the metal surface to approx. 300° C. to increase the tarnishing temperature of the metal surface resulting in a tarnishing temperature of the metal surface being above a temperature where a protective effect of the layer occurs.

22. The method according to claim 1, which further comprises providing the layer as an Si—O layer and the treating results in a tarnishing temperature of the metal surface being above a temperature where a protective effect of the Si—O layer occurs.

23. The method according to claim 21, which further comprises carrying out the treating step by heating the metal surface to up to 550° C. and subsequently dyeing the heated surface in mineral acid.

24. The method according to claim 21, which further comprises carrying out the coating step with a wet chemical process.

25. The method according to claim 21, which further comprises carrying out the coating step with a sol-gel process.

26. The method according to claim 23, which further comprises carrying out the coating step with a wet chemical process.

27. The method according to claim 23, which further comprises carrying out the coating step with a sol-gel process.

28. The method according to claim 1, which further comprises carrying out the coating step utilizing initial compounds having at least one of the general formulas RₙMeX₄₋ₙ and RₙMeX₃₋ₙ, where:
X is one of hydrolyzable groups and hydroxy groups;
R is at least one of hydrogen, alkyl, alkenyl, and alkinyl groups with up to 12 C atoms and aryl, aralkyl, and alkaryl groups with 6 to 10 C atoms;
n is 0, 1, or 2, always provided that at least one compound with n=1 or 2 is used; and
Me is Si, Al, Zr, B, or Ti.

29. The method according to claim 25, which further comprises carrying out the coating step utilizing, for the sol-gel process, initial compounds having at least one of the general formulas RₙMeX₄₋ₙ and RₙMeX₃₋ₙ, where:
X is one of hydrolyzable groups and hydroxy groups;
R is at least one of hydrogen, alkyl, alkenyl, and alkinyl groups with up to 12 C atoms and aryl, aralkyl, and alkaryl groups with 6 to 10 C atoms;
n is 0, 1, or 2, always provided that at least one compound with n=1 or 2 is used; and
Me is Si, Al, Zr, B, or Ti.

30. A method for coating metal surfaces excluding lithographic plates, which comprises:
one of:
roughening the metal surface to be coated with at least one of a mechanical roughening and a chemical roughening and subsequently coating the roughened surface with a layer having a thickness ranging from approximately 100 nm to approximately 1 μm; and
introducing a secondary phase by roughening the metal surface to be coated with at least one of a mechanical roughening and a chemical roughening at the same time as coating the roughened surface with a layer having a thickness ranging from approximately 100 nm to approximately 1 μm.

31. A component, comprising:
a metal surface excluding lithographic plates being one of:
at least one of mechanically and chemically roughened and subsequently coated with a layer having a thickness ranging from approximately 100 nm to approximately 1 μm; and
at least one of mechanically and chemically roughened at the same time as coated with a layer having a thickness ranging from approximately 100 nm to approximately 1 μm.

32. A component, comprising:
a metal surface excluding lithographic plates being one of:
roughened with at least one of a mechanical roughening and a chemical roughening and subsequently coated with a layer having a thickness ranging from approximately 100 nm to approximately 1 μm; and
roughened with at least one of a mechanical roughening and a chemical roughening at the same time as coated with a layer having a thickness ranging from approximately 100 nm to approximately 1 μm.
